(19) United States
(12) Patent Application Publication
(10) Pub. No.: US 2021/0073788 A1
(43) Pub. Date: Mar. 11, 2021

(54) INSTANT ISSUANCE OF PAYMENT DEVICES

(71) Applicant: Mastercard International Incorporated, Purchase, NY (US)

(72) Inventors: Mayank Prakash, Dehradun (IN); Satya Sudipta Padhiary, Mumbai (IN); Vairag Jain, Gurugram (IN)

(73) Assignee: Mastercard International Incorporated, Purchase, NY (US)

(21) Appl. No.: 17/011,023

(22) Filed: Sep. 3, 2020

(30) Foreign Application Priority Data
Sep. 5, 2019 (SG) 10201908199V

(51) Int. Cl. G06Q 20/34; G06K 9/62; G06Q 20/36; G06Q 20/38; H04L 29/06

(52) U.S. Cl. CPC G06Q 20/341; G06K 9/6215; H04L 63/0838; G06Q 20/385; G06Q 20/36

(57) ABSTRACT

A computer-implemented method for issuance of a payment device includes: generating, from a transaction history of a first payment device of a user, usage parameters characteristic of usage of the first payment device, the first payment device being enabled for a first transaction type; generating one or more similarity scores based on a comparison of the usage parameters of the first payment device to corresponding usage parameters of one or more other payment devices that are enabled for a second transaction type for which the first payment device is not enabled; determining, from the one or more similarity scores, one or more matching payment devices of the other payment devices that satisfy a matching criterion; determining payment device configuration parameters of the one or more matching payment devices; and encoding, or causing to be encoded, payment device data in one or more machine-readable media, wherein the payment device data includes a new payment device number, an indication that the new payment device number is enabled for the second transaction type, and selected ones of the payment device configuration parameters.

### CROSS REFERENCE TO RELATED APPLICATIONS

This application claims priority to Sinagporean Application No. 10201908199V, filed Sep. 5, 2019, which is incorporated herein by reference in its entirety.

### TECHNICAL FIELD

The present disclosure relates, in general terms, to methods and systems for issuance of payment devices.

### BACKGROUND

Issuance of a payment device, such as a credit card, is typically time-consuming and cumbersome. Processing of a cardholder application and subsequent production and delivery of a physical card involves many operations, which may not be well coordinated by the various parties involved.

One issue which can arise is that the issued credit card may not be properly delivered to the rightful cardholder for various reasons, such as an error in the delivery address, the cardholder not being available at the time of delivery, or a change in address that has not been notified to the issuing bank.

Another issue which can arise from a cardholder perspective is that it can be difficult to obtain approval for a credit card. As such, many consumers do not even attempt to apply, even though some may be eligible, for example because they already have a debit card.

### SUMMARY

The present disclosure relates to a computer-implemented method for issuance of a payment device, including:
generating, from a transaction history of a first payment device of a user, usage parameters characteristic of usage of the first payment device, the first payment device being enabled for a first transaction type;
generating one or more similarity scores based on a comparison of the usage parameters of the first payment device to corresponding usage parameters of one or more other payment devices that are enabled for a second transaction type for which the first payment device is not enabled;
determining, from the one or more similarity scores, one or more matching payment devices of the other payment devices that satisfy a matching criterion;
determining payment device configuration parameters of the one or more matching payment devices; and
encoding, or causing to be encoded, payment device data in one or more machine-readable media, wherein the payment device data includes a new payment device number, an indication that the new payment device number is enabled for the second transaction type, and selected ones of the payment device configuration parameters.

The one or more machine-readable media may include computer-readable storage of a computing device, a magnetic stripe card, and/or an integrated circuit (IC) card. The computing device may be a computing device of the user, for example.

The method may include obtaining the transaction history using a payment device number of the first payment device. The payment device number may be received as part of a request from a computing device of the user.

The encoding may include adding the new payment device number, or a token that is mapped to the new payment device number, to a digital wallet of the user.

In some embodiments, the one or more machine-readable media includes a magnetic stripe card or a smart card, and the encoding is at least partly carried out by a self-service terminal. The method may include transmitting a one-time passcode to a computing device of the user; wherein said encoding is only carried out on entry of the one-time passcode at the self-service terminal.

In some embodiments, the first transaction type is debit and the second transaction type is credit.

The usage parameters may be selected from one or more of: transaction frequency; transaction value; transaction type; merchant category; location; number or frequency of chargebacks; fraud rate; frequency of cross border transactions; and value of cross border transactions.

The matching criterion may be one of: the similarity score exceeding a threshold; or the other payment device having a highly-ranked similarity score.

In some embodiments, the payment device configuration parameters include one or more of: a credit limit or range of credit limits; a card type; and a loyalty program.

Embodiments may include transmitting, to the computing device of the user, an offer from a merchant, said merchant being selected according to the usage parameters of the one or more matching payment devices. The method may include transmitting a token to the merchant, the token being mapped to the payment device number.

The present disclosure also relates to a system for issuance of a payment device, including:
at least one processor in communication with computer-readable storage, the computer-readable storage having stored thereon instructions to cause the at least one processor to perform a method as disclosed herein.

The present disclosure also relates to a system for issuance of a payment device, including:
an issuer processor that is configured to:
   generate, from a transaction history of a first payment device of a user, usage parameters characteristic of usage of the first payment device, the first payment device being enabled for a first transaction type;
   generate one or more similarity scores based on a comparison of the usage parameters of the first payment device to corresponding usage parameters of one or more other payment devices that are enabled for a second transaction type for which the first payment device is not enabled;
   determine, from the one or more similarity scores, one or more matching payment devices of the other payment devices that satisfy a matching criterion;
   determine payment device configuration parameters of the one or more matching payment devices; and
   encode, or cause to be encoded, payment device data in one or more machine-readable media, wherein the payment device data includes a new payment device number, an indication that the new payment device number is enabled for the second transaction type, and selected ones of the payment device configuration parameters.

The one or more machine-readable media may include computer-readable storage of a computing device, a magnetic stripe card, and/or an integrated circuit (IC) card. The computing device may be a computing device of the user.

In some embodiments, the issuer processor is configured to obtain the transaction history using a payment device number of the first payment device. For example, the issuer processor may be configured to receive the payment device number as part of a request from a computing device of the user.

The system may include a digital wallet server that is configured to encode the payment device data by adding the new payment device number, or a token that is mapped to the new payment device number, to a digital wallet of the user.

In some embodiments, the system includes a card production apparatus that is configured to encode the payment device data on a magnetic stripe card or a smart card.

The card production apparatus may include, be part of, or be in communication with, a self-service terminal.

The issuer processor may be configured to transmit a one-time passcode to a computing device of the user; and the self-service terminal may be configured to encode the payment device data on entry of the one-time passcode at the self-service terminal.

In some embodiments, the first transaction type is debit and the second transaction type is credit.

Embodiments of the system include a merchant system that is configured to transmit, to the computing device of the user, an offer from a merchant, said merchant being selected according to the usage parameters of the one or more matching payment devices.

In some embodiments, the issuer processor is configured to transmit a token to the merchant system, the token being mapped to the payment device number.

The present disclosure further relates to one or more non-transitory computer-readable storage media having stored thereon instructions for causing at least one processor to perform a method as disclosed herein.

### BRIEF DESCRIPTION OF THE DRAWINGS

Embodiments of the invention will now be described, by way of non-limiting example, by reference to the drawings in which:

FIG. 1 is a system architecture diagram of an example system for issuance of a payment device;

FIG. 2 is a flow diagram of an embodiment of a method for issuance of a payment device;

FIG. 3 is a high-level flow diagram of a payment device encoding process executed by an issuer processor device;

FIG. 4 is a high-level flow diagram of a payment device encoding process executed by a card production apparatus;

FIG. 5 is an exemplary architecture of a card production apparatus;

FIG. 6 is an exemplary architecture of a mobile computing device of the system of FIG. 1; and

FIG. 7 is an exemplary architecture of an issuer processor device of the system of FIG. 1.

### DETAILED DESCRIPTION

Embodiments of the invention generally relate to methods and systems for issuance of payment devices on demand, also referred to herein as “instant issuance”. Embodiments enable a user of a payment device of a first kind that is enabled only for a certain transaction type, such as debit transactions, to request and obtain a payment device of a second kind that is enabled for an additional transaction type, such as credit transactions.

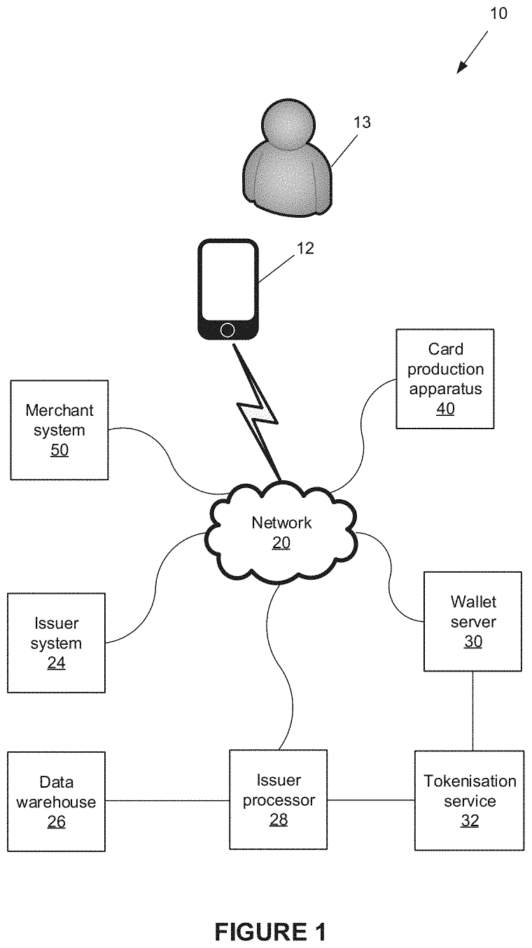

For example, in FIG. 1, a system 10 includes a computing device 12 of a user 13 that is in communication with an issuer system 24 via a network 20, such as the public Internet. The issuer system 24 hosts an account of the user 13. For example, the account may be hosted on a core banking system of the issuer system 24, that is not directly accessible via network 20. The issuer system 24 may include an interface such as a secure application server (e.g., a mobile banking server) that enables the user 13 to access the account hosted at the core banking system, using a dedicated application or web browser executing on computing device 12.

Additionally, the user 13 may make a request at the issuer system 24, using the dedicated application or web browser (for example), for issuance of a payment device such as a physical or virtual credit card. The request is received by issuer system 24, which transmits a processing request to an issuer processor 28. The issuer processor 28 may be operated by the same entity as issuer system 24, and may, for example, be hosted in the same physical location. Accordingly, communication between issuer system 24 and issuer processor 28 may be via a private network, rather than public network 20. In some embodiments, the issuer processor 28 is physically and/or logically separated from issuer system 24. For example, the issuer processor 28 may be operated by a card network such as Mastercard, or by a third party processor.

The processing request may include data identifying a first payment device of the user 13, such as a debit card. Issuer processor 28 may obtain a transaction history of the first payment device, for example by querying data warehouse 26, and determine one or more usage parameters (such as transaction frequency) of the first payment device. Issuer processor 28 also obtains corresponding usage parameters of one or more other payment devices of a different type than the first payment device, such as credit cards. That is, the other payment devices are enabled for a transaction type that the first payment device is not enabled for.

Issuer processor 28 may benchmark the first payment device against the other payment devices by comparing their respective usage parameters. For example, where the first payment device is a debit card and the other payment devices are credit cards, usage parameters derived from the transaction history of the debit card may be compared against the usage parameters derived from the respective transaction histories of the credit cards to find “lookalikes” among the credit cards.

The issuer processor 28 may determine a similarity score (for example, on a scale of 0 to 100) indicative of how closely usage of the debit card matches usage of one or more credit cards (e.g., individual credit cards, or groups of credit cards that have been clustered according to their usage). On the basis of the similarity score, the issuer processor 28 may select one or more “lookalike” credit cards, and determine payment card configuration parameters from the one or more “lookalike” cards, such as credit limit, card type (e.g. a card tier such as “Platinum”), and loyalty program (e.g. air miles card with extra weighting applied to spend in particular categories, such as travel, entertainment, etc.).

The issuer processor 28 may then generate a payment device number, and encode, or cause to be encoded, payment device data (including the payment device number and selected ones of the determined payment card configuration parameters) in a machine-readable medium.

For example, the machine-readable medium may be a computer-readable medium such as storage of the user device 12, or of a digital wallet server 30 which stores a digital wallet of the user 13, such that the instant issuance is of a virtual card. In another example, the machine-readable medium may be a physical card such as a magnetic stripe card or an integrated circuit (IC) card. In that case, the issuer processor 28 may transmit the payment device data to a remote device such as card production apparatus 40. The card production apparatus may carry card blanks that can be personalised using, inter alia, the payment device data. The personalised cards may be dispensed to user 13 on entry by the user 13 of a one-time passcode transmitted to user device 12 by secure application server 22 or digital wallet server 30, for example.

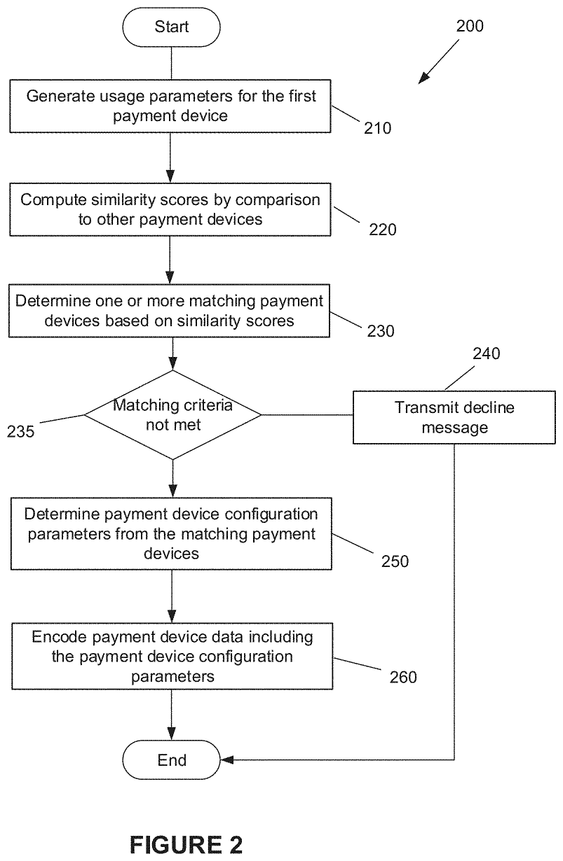

FIG. 2 shows an example of a set of operations performed by an issuer processor, for example, in an embodiment of a computer-implemented method 200 for issuance of a payment device. The method 200 includes a first operation 210 of generating, from a transaction history of a first payment device of a user, usage parameters characteristic of usage of the first payment device, the first payment device being enabled for a first transaction type. In the example discussed below, the first transaction type is debit transactions.

For example, an issuer processor 28 may receive data identifying the first payment device, such as a payment device number, for example a primary account number (PAN). The data identifying the first payment device may be received from issuer system 24 in response to a request from user 13, whose account is associated with the first payment device and is maintained by issuer system 24, for issuance of a new payment device. The request may be submitted by user 13 via a computing device 12, such as a mobile device, or via a self-service terminal such as an ATM.

The issuer processor 28 may then obtain, using the identification of the first payment device, a transaction history of the first payment device. The transaction history may be limited to a particular period, such as the last year, the last two years, etc. The transaction history includes one or more transactions, each of which may be characterised by a number of parameters, including: a timestamp; a transaction value; a merchant identifier of a merchant at which the transaction was completed; a merchant category code; a transaction location; and a transaction currency.

The issuer processor 28 may obtain the transaction history by querying a database of issuer system 24. Alternatively, the transaction history may be obtained by querying a data warehouse 26 which is operated by a third party (for example, a payment network such as Mastercard) and which stores all transactions that are processed by that third party. As the transaction history is for a payment device issued by the issuer system 24, it may be advantageous to query only the issuer system 24, as the search space for the query is reduced.

Once the issuer processor 28 obtains the transaction history, usage parameters characterising the usage of the first payment device may be determined. For example, issuer processor 28 may determine one or more of the following: transaction frequency; transaction value; transaction type; merchant category; location; number or frequency of chargebacks; fraud rate; frequency of cross border transactions; and value of cross border transactions.

In some embodiments, the issuer processor 28 may compute a similarity score that is a weighted combination, such as a weighted sum, of the usage parameters or values derived therefrom. The weighted combination may be, for example, a similarity metric that includes weights for two or more of the usage parameters or values derived therefrom. The weights may be defined a priori, or may be learned from the data.

For example, the issuer processor 28 may perform an operation 220 of generating one or more similarity scores based on a comparison of the usage parameters of the first payment device to corresponding usage parameters of one or more other payment devices that are enabled for a second transaction type for which the first payment device is not enabled.

For example, the second transaction type may be credit transactions. Accordingly, the issuer processor 28 may compare the usage patterns of a debit card user to those of a different group, namely credit card users.

The similarity scores may be generated in a number of different ways known in the art. For example, where the usage parameters are all numerical, a similarity score may be computed using a similarity metric such as, for example, a cosine similarity, Euclidean distance, or Mahalanobis distance between a vector of usage parameters of the first payment device, and a vector of usage parameters of one of the other payment devices. If any usage parameters are non-numerical, they may be converted to numerical values prior to determining the similarity score. In some embodiments, the similarity metric may be modified to include weights for respective usage parameters, and the weights may be set a priori or learned from training data.

In some embodiments, if the usage parameters are on different scales, they may be rescaled prior to determining the similarity score. Alternatively, the overall similarity score for the set of usage parameters may be computed as a weighted combination of similarity scores for individual usage parameters (e.g., Gower's generalised similarity coefficient).

In some embodiments, the similarity may be computed between the usage parameters of the first payment device and an average vector of usage parameters of a set of other payment devices. For example, the set of other payment devices may be clustered into groups on the basis of one or more variables, such as cardholder address (e.g., based on zip code or set of zip codes, or city), credit limit, card type (product code), loyalty program, and/or one or more of the usage parameters themselves. In one specific example, the issuer processor 28 may extract, from data warehouse 26, a set of payment devices for a specific card type having a certain range of credit limits, and determine the average usage parameters (such as average transaction frequency, average ticket size, frequency of online transactions, etc.) for the extracted set of payment devices.

In some embodiments, where one or more usage parameters are non-numerical, the issuer processor 28 may determine an encoding of the non-numerical usage parameters to more readily enable determination of similarity between the usage pattern of the first payment device and usage patterns of the other payment devices.

For example, if a usage parameter relates to merchant category codes, the issuer processor 28 may apply one-hot encoding to the merchant category codes of transactions of the first payment device, and the same encoding to the merchant category codes of the transactions of the other payment devices. In some embodiments, the contribution of the usage parameter to the similarity score may then be computed by, for example, applying an AND operation to the respective one-hot vectors, and summing the components of the resulting vector.

In another example, the issuer processor 28 may populate a vector with the number or average value of transactions conducted with merchants in respective merchant categories. This may be done for the first payment device, and for each of the other payment devices, and the contribution of the usage parameter to the similarity score may be computed by determining a distance or cosine similarity between the vector for the first payment device and the vector or vectors for the other payment devices. As above, the other payment devices may be pooled or averaged by a clustering operation.

The method 200 may include an operation 230 of determining, from the one or more similarity scores, one or more matching payment devices of the other payment devices that satisfy a matching criterion.

For example, the matching criterion may be that the similarity score exceeds a threshold. If the similarity score is normalised, such as to be on a scale between 0 and 100, the threshold may be a similarity score of 80 or 90, for example. Alternatively, the matching criterion may be a high ranking for the similarity score, such as the highest similarity score, the top 3 similarity scores, etc. The issuer processor 28 may select a single matching payment device, or a set of matching payment devices, based on the matching criterion.

At 235, the issuer processor 28 may determine whether the matching criterion has been met. If not, the issuer processor 28 may apply one or more alternative matching criteria. For example, if no payment device produces a similarity score above the threshold, the issuer processor 28 may instead apply a rank-based matching criterion. If no criteria are met, issuer processor 28 may determine that the first payment device does not display usage behaviour similar to that of users of the other payment devices, and send, at 240, a decline message, for example to issuer system 24 and/or user device 12. In that case, the process 200 ends.

Assuming that one or more matching criteria are met, at step 250, the issuer processor 28 may determine payment device configuration parameters of the one or more matching payment devices.

For example, the issuer processor 28 may determine a card type, loyalty program, and/or a credit limit or range of credit limits, for each of the one or more matching payment devices. It will be appreciated that there may be more than one value for each of these configuration parameters. Accordingly, the issuer processor 28 may select, or provide to issuer system 24 and/or user device 12 as a set of options, values of the configuration parameters.

The issuer processor 28 then generates, at step 260, payment device data. The payment device data includes a new payment device number, such as a PAN, the selected payment device configuration parameters, and optionally, an indication that the new payment device number is enabled for the second transaction type. For example, the indication that the new payment device number is enabled for the second transaction type may be encoded in a product code, which may also specify the specific variant of the payment device (e.g., Platinum card). The payment device data may also include an expiry date and card verification code (CVC), for example. The issuer processor 28 then encodes, or causes to be encoded, the payment device data in one or more machine-readable media.

The machine-readable media may include computer-readable storage of the user computing device 12, the issuer system 24, and/or a wallet server 30 that maintains a digital wallet account for the user 13. For example, the new payment device number and payment device configuration parameters may be written to storage of the core banking system of issuer system 24, and associated with the account of user 13, such that user 13 can not only use their existing payment device that is enabled only for debit transactions, but can also use the newly issued payment device number that is enabled for credit transactions. The new payment device number may be transmitted to the user computing device 12, for example, so that it is available for the user 13 to use for on-line transactions.

In some embodiments, issuer processor 28 may tokenise the newly generated payment device number, and to this end, sends a tokenisation request to tokenisation service 32. The tokenisation service 32 may be Mastercard Digital Enablement Service (MDES), for example.

The tokenisation service 32 maps the new payment device number to another number called a token, for example having the same format, and stores the mapping in a token vault. The token is then transmitted back to issuer processor 28, and may form part of the payment device data that is encoded, or caused to be encoded, by issuer processor 28. The token may be stored by issuer system 24 and/or transmitted to user device 12. It will be understood that the token may be used in lieu of the actual payment device number in, for example, online transactions, and that any such use will involve detokenisation during the transaction flow (by tokenisation service 32) in known manner.

The machine-readable media may also, or alternatively, include a magnetic stripe card or integrated circuit (IC) card. The issuer processor 28 may cause encoding of the payment device data on the magnetic stripe card or IC card via a card production apparatus 40.

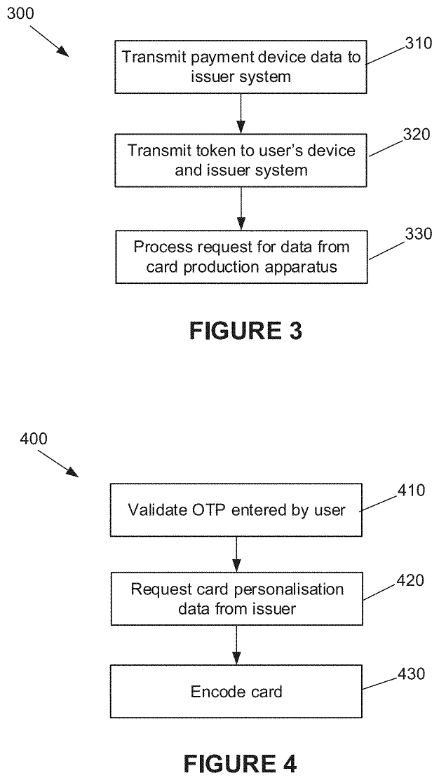

For example, FIGS. 3 and 4 show certain operations performed by issuer processor 28 and card production apparatus 40 as part of a card encoding process.

The issuer processor 28 may transmit the payment device data to issuer system 24, at step 310. At step 320, the issuer processor 28 transmits a token to the user's device 12, and to the issuer system 24. The token may be the same token as stored by issuer system 24 and in the tokenisation vault of tokenisation service 32, or may be an additional token that is generated by issuer processor 28.

On receipt of the token, the user 13 may enter it at a terminal of card production apparatus 40, to initiate a request to generate a physical card. The card production apparatus 40 may prompt the user 13 to enter a one-time passcode (OTP). This may be transmitted to the user's device 12 by the issuer system 24, triggered by the card production apparatus 40 contacting the issuer system 24. Alternatively, the user 13 may receive a one-time passcode by requesting it through user device 12, in particular through a mobile banking application that communicates with issuer system 24.

Turning to FIG. 4, in process 400 performed by card production apparatus 40, the card production apparatus 40 receives the OTP entered by user 13, and validates it by contacting issuer system 24 and/or issuer processor 28. If the OTP is successfully validated, card production apparatus 40 requests card personalisation data from issuer system 24, at step 420. The card personalisation data may be prepared by issuer system 24, or by issuer processor 28 on behalf of issuer system 24, at step 330 of process 300.

The card personalisation data includes the new payment device number, expiry date and CVC, and may also include card personalisation keys for use in encryption carried out as part of EMV transactions, and a card profile that specifies data, including risk parameters, that dictates the functional behavior of the card when used by the cardholder at a supported acceptance device such as a payment terminal, or a transit gate or other access point. The risk parameters may be used by the acceptance device in order to determine whether to allow an authorisation request from the card, and/or whether to change the manner in which the authorisation request is processed. For example, one risk parameter may be a threshold transaction value below which a contactless payment request will be forwarded without requiring further authentication by the cardholder.

At step 430 of process 400, the card production apparatus 40 receives the card personalisation data from issuer system 24 or issuer processor 28, and encodes the card with the card personalisation data. The card production apparatus 40 may also perform additional processing steps, such as embossing the card with the payment device number, and printing graphics (such as the issuer's logo and a payment network logo) and text (such as the expiry date and CVC) on the card surfaces. Once complete, the card is dispensed to user 13.

Some exemplary architectures of various components of the system 10 will now be described.

### Card Production Apparatus 40

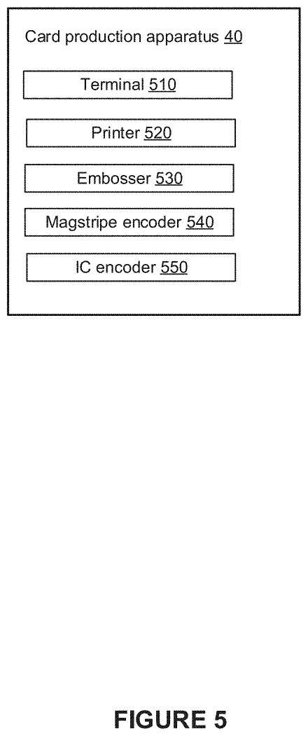

Referring to FIG. 5, a card production apparatus 40 includes a terminal 510 for enabling interaction with a user 13. The user 13 may use terminal 510 to make requests for issuance of payment devices, and enter input data, such as a token number and OTP, as described above.

The terminal 510 may form part of the card production apparatus 40 itself, as shown in FIG. 5. Alternatively, the terminal may be part of (or may be) a separate device, such as a self-service terminal, with which the card production apparatus 40 communicates. For example, terminal 510 may be an automated teller machine (ATM), via which user 13 may, for example, insert or tap an existing payment device to transmit payment device data to identify themselves. In some embodiments, a request for issuance of a payment device may be made through another channel, such as via a mobile banking application. On approval, issuer processor 28 may store approval data in association with the user's account, and the user 13 may be prompted to finalise the request (and to produce a physical card) via the self-service terminal on inserting or tapping their existing payment device at the ATM.

Card production apparatus 40 also includes a receptacle for storing card blanks, a printer 520 for printing graphics and text on card surfaces, and an embosser 530 for embossing the payment card number into the card.

Further, card production apparatus 40 has a magnetic stripe encoder 540 for encoding card personalisation data into a magnetic stripe of the card, and an IC encoder 550 for encoding card personalisation data into an integrated circuit of the card. Typically, the information encoded by IC encoder 550 will differ from that encoded by magstripe encoder 540. For example, IC encoder 550 may encode additional information relevant to EMV transactions, such as EMV applications (e.g. a credit application such as MChip of Mastercard International Incorporated), and cryptographic keys used for signing or encrypting transaction-related information.

### User Device 12

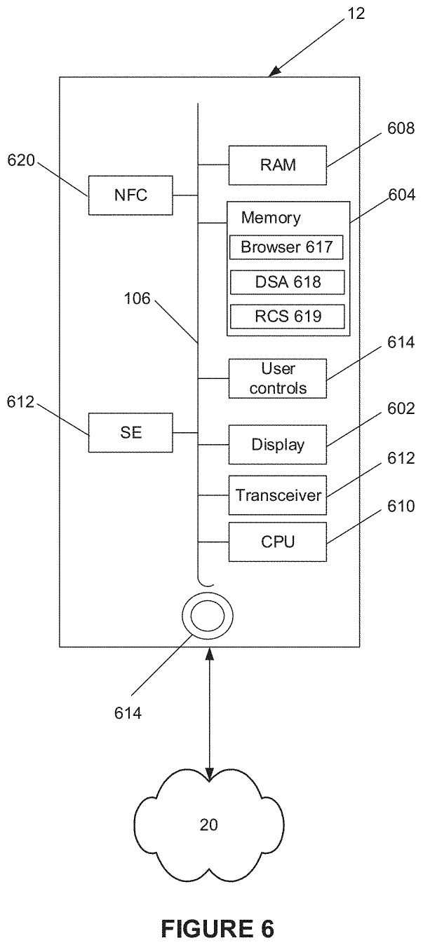

FIG. 6 is a block diagram showing an exemplary computing device of a user, which may be a mobile computer device 12 such as a smart phone, a tablet, a personal data assistant (PDA), a palm-top computer, or multimedia Internet enabled cellular telephone. For ease of description, the mobile computer device 12 is described below, by way of non-limiting example, with reference to a mobile device in the form of a smart phone.

As shown, the mobile computer device 12 includes the following components in electronic communication via a bus 606:
(a) a display 602;
(b) non-volatile (non-transitory) memory 604;
(c) random access memory (“RAM”) 608;
(d) N processing components 610;
(e) a transceiver component 612 that includes N transceivers;
(f) user controls 614;
(g) a secure element 616; and
(h) a NFC controller 620.

Although the components depicted in FIG. 6 represent physical components, FIG. 6 is not intended to be a hardware diagram. Thus, many of the components depicted in FIG. 6 may be realised by common constructs or distributed among additional physical components. Moreover, it is certainly contemplated that other existing and yet-to-be developed physical components and architectures may be utilised to implement the functional components described with reference to FIG. 6.

The display 602 generally operates to provide a presentation of content to a user, and may be realised by any of a variety of displays (e.g., CRT, LCD, HDMI, micro-projector and OLED displays).

In general, the non-volatile data storage 604 (also referred to as non-volatile memory) functions to store (e.g., persistently store) data and executable code.

In some embodiments for example, the non-volatile memory 604 includes bootloader code, modem software, operating system code, file system code, and code to facilitate the implementation components, known to those of ordinary skill in the art, which are not depicted nor described for simplicity.

In many implementations, the non-volatile memory 604 is realised by flash memory (e.g., NAND or ONENAND memory), but it is certainly contemplated that other memory types may be utilised as well. Although it may be possible to execute the code from the non-volatile memory 604, the executable code in the non-volatile memory 604 is typically loaded into RAM 608 and executed by one or more of the N processing components 610.

The N processing components 610 in connection with RAM 608 generally operate to execute the instructions stored in non-volatile memory 604. As one of ordinarily skill in the art will appreciate, the N processing components 610 may include a video processor, modem processor, DSP, graphics processing unit (GPU), and other processing components.

The transceiver component 612 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The mobile computer device 12 can execute mobile applications, such as a mobile banking application 618. The mobile banking application 618 could be a mobile application, web page application, or computer application. The mobile banking application 618 may be accessed by a computing device such as mobile computer device 12, or a wearable device such as a smartwatch.

It should be recognised that FIG. 6 is merely exemplary and in one or more exemplary embodiments, the functions described herein may be implemented in hardware, software, firmware, or any combination thereof. If implemented in software, the functions may be transmitted or stored as one or more instructions or code encoded on a non-transitory computer-readable medium 604. Non-transitory computer-readable medium 604 includes both computer storage medium and communication medium including any medium that facilitates transfer of a computer program from one place to another. A storage medium may be any available medium that can be accessed by a computer.

### Issuer Processor 28

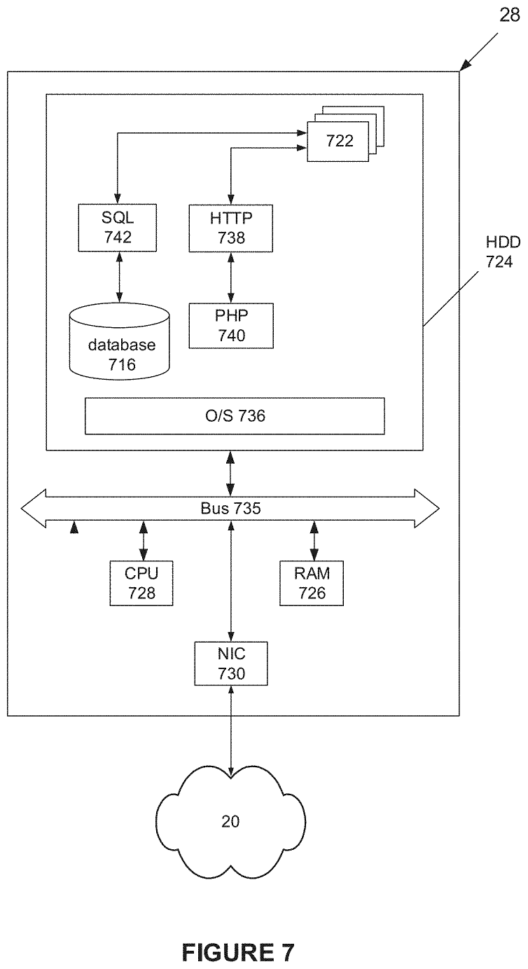

FIG. 7 shows an example computing device 28 that is capable of implementing a issuer processor device of the system 10. In some embodiments, multiple computing devices 28 may be considered to be a single issuer processor device.

The components of the computing device 28 can be configured in a variety of ways.

The components can be implemented entirely by software to be executed on standard computer server hardware, which may comprise one hardware unit or different computer hardware units distributed over various locations, which may communicate over a network. Some of the components or parts thereof may also be implemented by application specific integrated circuits (ASICs) or field programmable gate arrays.

In the example shown in FIG. 7, the computing device 28 is a commercially available server computer system based on a 32 bit or a 64 bit Intel architecture, and the processes and/or methods executed or performed by the computing device 28 are implemented in the form of programming instructions of one or more software components or modules 722 stored on non-volatile (e.g., hard disk) computer-readable storage 724 associated with the computing device 30. At least parts of the software modules 722 could alternatively be implemented as one or more dedicated hardware components, such as application-specific integrated circuits (ASICs) and/or field programmable gate arrays (FPGAs).

The computing device 28 includes at least one or more of the following standard, commercially available, computer components, all interconnected by a bus 735:
(a) random access memory (RAM) 726;
(b) at least one computer processor 728, and
(c) a network interface connector (NIC) 730 which connects the computer device 28 to a data communications network and/or to external devices.

The computing device 28 includes a plurality of standard software modules, including:
(a) an operating system (OS) 736 (e.g., Linux or Microsoft Windows);
(b) web server software 738 such as Apache, available at http://www.apache.org;
(c) scripting language support 740 such as PHP, available at http://www.php.net, or Microsoft ASP; and
(d) structured query language (SQL) modules 742 (e.g., MySQL, available from http://www.mysql.com), which allow data to be stored in and retrieved/accessed from an SQL database 716.

Together, the web server 738, scripting language module 740, and SQL module 742 provide the issuer processor device 28 with the general ability to allow users of the Internet 20 with standard computing devices equipped with standard web browser software to access the issuer processor device 28 and in particular to provide data to and receive data from the database 716.

However, it will be understood by those skilled in the art that the specific functionality provided by the issuer processor device 28 to such users is provided by scripts accessible by the web server 738, including the one or more software modules 722 implementing the processes, and also any other supporting scripts and data (not shown), including markup language (e.g., HTML, XML) scripts, PHP (or ASP), and/or CGI scripts, image files, style sheets, and the like.

Advantageously, the database 716 forms part of the computer readable data storage 724. Alternatively, the database 716 is located remote from the server 28 shown in FIG. 7.

The boundaries between the modules and components in the software modules 722 are exemplary, and alternative embodiments may merge modules or impose an alternative decomposition of functionality of modules. For example, the modules discussed herein may be decomposed into submodules to be executed as multiple computer processes, and, optionally, on multiple computers. Moreover, alternative embodiments may combine multiple instances of a particular module or submodule. Furthermore, the operations may be combined or the functionality of the operations may be distributed in additional operations in accordance with the invention. Alternatively, such actions may be embodied in the structure of circuitry that implements such functionality, such as the micro-code of a complex instruction set computer (CISC), firmware programmed into programmable or erasable/programmable devices, the configuration of a field-programmable gate array (FPGA), the design of a gate array or full-custom application-specific integrated circuit (ASIC), or the like.

Each of the blocks of the flow diagrams of the processes 200, 300 of the computing device 28 may be executed by a module (of software modules 722) or a portion of a module. The processes may be embodied in a non-transient machine-readable and/or computer-readable medium for configuring a computer system to execute the method. The software modules may be stored within and/or transmitted to a computer system memory to configure the computer system to perform the functions of the module.

The computing device 28 normally processes information according to a program (a list of internally stored instructions such as a particular application program and/or an operating system) and produces resultant output information via input/output (I/O) devices 730. A computer process typically includes an executing (running) program or portion of a program, current program values and state information, and the resources used by the operating system to manage the execution of the process. A parent process may spawn other, child processes to help perform the overall functionality of the parent process. Because the parent process specifically spawns the child processes to perform a portion of the overall functionality of the parent process, the functions performed by child processes (and grandchild processes, etc.) may sometimes be described as being performed by the parent process.

It will be appreciated that many further modifications and permutations of various features of the described embodiments are possible. Accordingly, the described features are intended to embrace all such alterations, modifications, and variations that fall within the spirit and scope of the appended claims.

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavor to which this specification relates.

1. A computer-implemented method for issuance of a payment device, including:
generating, from a transaction history of a first payment device of a user, usage parameters characteristic of usage of the first payment device, the first payment device being enabled for a first transaction type;
generating one or more similarity scores based on a comparison of the usage parameters of the first payment device to corresponding usage parameters of one or more other payment devices that are enabled for a second transaction type for which the first payment device is not enabled;
determining, from the one or more similarity scores, one or more matching payment devices of the other payment devices that satisfy a matching criterion;
determining payment device configuration parameters of the one or more matching payment devices; and
encoding, or causing to be encoded, payment device data in one or more machine-readable media, wherein the payment device data includes a new payment device number, an indication that the new payment device number is enabled for the second transaction type, and selected ones of the payment device configuration parameters.

2. A method according to claim 1, wherein the one or more machine-readable media includes computer-readable storage of a computing device, a magnetic stripe card, and/or an integrated circuit (IC) card.

3. A method according to claim 1, wherein said encoding includes adding the new payment device number, or a token that is mapped to the new payment device number, to a digital wallet of the user.

4. A method according to claim 1, wherein the one or more machine-readable media includes a magnetic stripe card or a smart card, and the encoding is at least partly carried out by a self-service terminal.

5. A method according to claim 4, including transmitting a one-time passcode to a computing device of the user; wherein said encoding is only carried out on entry of the one-time passcode at the self-service terminal.

6. A method according to claim 1, wherein the first transaction type is debit and the second transaction type is credit.

7. A method according to claim 1, wherein the matching criterion is one of: the similarity score exceeding a threshold; or the other payment device having a highly-ranked similarity score.

8. A method according to claim 1, wherein the payment device configuration parameters include one or more of: a credit limit or range of credit limits; a card type; and a loyalty program.

9. A method according to claim 1, including transmitting, to a computing device of the user, an offer from a merchant, said merchant being selected according to the usage parameters of the one or more matching payment devices.

10. A method according to claim 9, including transmitting a token to the merchant, the token being mapped to the payment device number.

11. A system for issuance of a payment device, including:
an issuer processor that is configured to:
generate, from a transaction history of a first payment device of a user, usage parameters characteristic of usage of the first payment device, the first payment device being enabled for a first transaction type;
generate one or more similarity scores based on a comparison of the usage parameters of the first payment device to corresponding usage parameters of one or more other payment devices that are enabled for a second transaction type for which the first payment device is not enabled;
determine, from the one or more similarity scores, one or more matching payment devices of the other payment devices that satisfy a matching criterion;
determine payment device configuration parameters of the one or more matching payment devices; and
encode, or cause to be encoded, payment device data in one or more machine-readable media, wherein the payment device data includes a new payment device number, an indication that the new payment device number is enabled for the second transaction type, and selected ones of the payment device configuration parameters.

12. A system according to claim 11, wherein the one or more machine-readable media includes computer-readable storage of a computing device, a magnetic stripe card, and/or an integrated circuit (IC) card.

13. A system according to claim 11, further including a digital wallet server that is configured to encode the payment device data by adding the new payment device number, or a token that is mapped to the new payment device number, to a digital wallet of the user.

14. A system according to claim 11, further including a card production apparatus that is configured to encode the payment device data on a magnetic stripe card or a smart card.

15. A system according to claim 14, wherein the card production apparatus includes, is part of, or is in communication with, a self-service terminal.

16. A system according to claim 15, wherein the issuer processor is configured to transmit a one-time passcode to a computing device of the user; and wherein the self-service terminal is configured to encode the payment device data on entry of the one-time passcode at the self-service terminal.

17. A system according to claim 11, wherein the first transaction type is debit and the second transaction type is credit.

18. A system according to claim 11, including a merchant system that is configured to transmit, to a computing device of the user, an offer from a merchant, said merchant being selected according to the usage parameters of the one or more matching payment devices.

19. A system according to claim 18, wherein the issuer processor is configured to transmit a token to the merchant system, the token being mapped to the payment device number.

20. One or more non-transitory computer-readable storage media having stored thereon instructions for causing at least one processor to perform a method according to claim 1.
